(19) United States
(12) Patent Application Publication
(10) Pub. No.: US 2023/0312410 A1
(43) Pub. Date: Oct. 5, 2023

(54) REGENERATION MATERIAL FOR REGENERATION OF A SALT MELT USED FOR A GLASS TOUGHENING AND/OR GLASS STRENGTHENING PROCESS

(71) Applicant: TECHNISCHE UNIVERSITÄT BERGAKADEMIE FREIBURG, Freiburg (DE)

(72) Inventors: Thomas VOLAND, Grossweitzchen (DE); Martin GROSS, Pockau-Lengefeld (DE)

(21) Appl. No.: 18/024,361

(22) PCT Filed: Sep. 2, 2021
(86) PCT No.: PCT/EP2021/074287

§ 371 Date: Mar. 2, 2023

(30) Foreign Application Priority Data
Sep. 3, 2020 (LU) LU102047

(51) Int. Cl. C03C 21/00

(52) U.S. Cl. CPC C03C 21/002

(57) ABSTRACT

The invention relates inter glia to a regeneration material for regeneration of a salt melt used for a glass toughening and/or glass strengthening process, comprising potassium nitrate or consisting of potassium nitrate. The regeneration material comprises a potassium-containing silicate glass or consists of a potassium-containing silicate glass.

### CROSS-REFERENCE TO RELATED APPLICATIONS

The present application is a national phase entry under 35 USC § 371 of International Application PCT/EP2021/074287 filed Sep. 2, 2021, claiming priority to and benefit of Luxembourgian Patent Application No. 102047 filed Sep. 3, 2020, the entire disclosure of which is incorporated herein by reference.

### FIELD

The disclosure relates to a regeneration material for regenerating a salt melt which is used for a glass hardening and/or glass strengthening process and which comprises potassium nitrate or consists of potassium nitrate.

The disclosure further relates to the use of such a regeneration material.

The disclosure relates, furthermore, to a plant for hardening and/or strengthening glass, comprising a salt bath with a salt melt which comprises potassium nitrate or consists of potassium nitrate.

The disclosure relates additionally to a method for hardening and/or strengthening glass articles.

### BACKGROUND

It is known that through ion exchange within a thin surface layer it is possible to achieve strong compressive stresses, which considerably improve the strength properties of the glass, if glass is subjected to defined treatment in a salt melt. In the course of the treatment in a salt melt, ions of a first type migrate into the glass, while at the same time the glass releases ions of a second type into the salt melt. Disadvantageously, the effect of the salt melt decreases depending on the frequency at which it is used, in particular because the salt melt becomes depleted in ions of the first type and there is accumulation of ions of the second type in the salt melt. As a result of this, the salt melt has to be replaced frequency.

It is known practice in particular to carry out a prestressing process at elevated temperatures in a potassium nitrate salt melt, where small alkali metal ions (sodium, lithium) are substituted for larger potassium ions. However, the substituted alkali metal ions remain in the salt melt, so reducing the activity of the salt melt. Moreover, for the outcome of the prestressing process, in a disadvantageous way, the salt melt undergoes decompression by way of the nitrate to form the hydroxide.

The increasing deterioration of the activity of the salt melt may be at least retarded through the use of a regeneration material.

For example, DE 17 71 232 B2 discloses a method for exchanging ions between a salt melt and glass for the purpose of altering the properties thereof, where the ions that have migrated into the salt melt are taken up by a regeneration material present in a separated phase in the salt melt, and at the same time ions required for the ion exchange are delivered to the salt melt. A salt melt is used which is admixed, as regeneration material, with an auxiliary substance which is an acceptor of oxygen ions or has an acid function and which is capable of forming complexes, with inclusion of the ions that have migrated from the glass or from the regeneration material into the salt melt, and which promotes redox reactions in the salt melt.

DE 22 60 278 C3 discloses a method for continuously regenerating a salt melt bath which is employed in ion exchange for glasses. In the method, an anode and a cathode are introduced into the salt melt bath, with the cathode being disposed in a chamber filled with the salt melt, said chamber being isolated from the rest of the salt melt bath by means of a dividing wall comprising a material which relative to the salt melt is corrosion-resistant and on account of its continuous pores is permeable for the salt melt, and yet has a high resistance relative to the diffusion flow of substances harmful for the substitution treatment. A voltage is applied via the anode and cathode for the flow of electrical current, and consequently a portion of the salt melt contained in the chamber and accumulated with the harmful substances is drawn off intermittently or continuously.

### SUMMARY

It is an object of the present disclosure to specify a possibility for durably maintaining or at least prolonging the usability of a salt melt which comprises potassium nitrate or consists of potassium nitrate and which serves for the hardening and/or strengthening of glass.

The object is achieved by the use of potassium-containing silicate glass as regeneration material.

It is a further object of the present disclosure to specify a regeneration material which enables the usability of a salt melt which comprises potassium nitrate or consists of potassium nitrate and which serves for the hardening and/or strengthening of glass to be durably maintained or at least prolonged.

The further object is achieved by a regeneration material which is characterized in that the regeneration material comprises a potassium-containing silicate glass or consists of a potassium-containing silicate glass.

It is a further object of the present disclosure to specify a plant of the type stated at the outset that permits the hardening and/or strengthening of a particularly large number of glass articles without having to replace the salt melt.

This further object is achieved by a plant as claimed in claim 43.

It is a further object of the present disclosure to specify a method which allows the hardening and/or strengthening of a particularly large number of glass articles without having to replace the salt melt.

This further object is achieved by a method which is characterized in that the glass to be hardened and/or strengthened is immersed in a salt melt which comprises potassium nitrate or consists of potassium nitrate and in that the salt melt is contacted progressively or at time-spaced intervals with a regeneration material of the disclosure.

The disclosure has the very particular advantage that three key aging phenomena of a salt melt can be prevented or at least very substantially delayed. In particular, an increase in the concentration of extraneous alkali metal ions is prevented or at least very substantially delayed. Moreover, an increase in the pH of the salt melt due to salt decomposition is prevented or at least very substantially delayed. Furthermore, particulate impurities are prevented, particularly by the binding of particulate impurities in the salt melt as soon as they come into contact with the regeneration material within the salt melt.

The regeneration material may be used especially advantageously in a salt melt which has a temperature of less than 495 degrees Celsius, more particularly of less than 480 degrees Celsius, or which has a temperature of 440 degrees Celsius. At such a temperature there is efficient ion exchange of the salt melt not only with the regeneration material of the disclosure but also with the glass articles to be strengthened and/or hardened in the salt melt. This is the case in particular if the glass articles are manufactured of alkali-containing silicate glass, more particularly of alkali metal-alkaline earth metal silicate glass, very particularly of soda-lime glass, or of borosilicate glass, or of aluminosilicate glass.

Moreover, the regeneration material of the disclosure has no adverse effects on a plant for the hardening and/or strengthening of glass articles. The regeneration material of the disclosure in particular does not cause any corrosive reactions with the glass articles to be hardened and/or strengthened, or with the salt bath. Furthermore, the introduction of the regeneration material into the salt bath and the removal of the regeneration material from the salt bath again are simple and uncomplicated possibilities, since it is contacted in the form of a solid (for example, in the form of beads, granules, plates, corrugated plates, irregularly corrugated plates, plates with irregular surface, or glass fibers or as nonwoven or glass frits or sintered material) with the salt melt. In particular the regeneration material can be introduced easily and uncomplicatedly into a salt melt and removed again from the salt melt (more on this below).

The regeneration material of the disclosure advantageously contains no harmful substances or compounds. In particular the regeneration material of the disclosure is neither toxic nor dangerous to the environment.

Particularly since the regeneration material is a glass, there is advantageously capacity for full recycling. More particularly, after its use in the disclosure, the regeneration material may be used as raw material for other applications or as raw material for the production of glass articles. For example, after its use in the disclosure, the regeneration material may be cleaned to remove adhering salt and used as raw material for the production of silicatic high-volume glasses.

The disclosure additionally has the particular advantage that an application may be employed independently of the shape or size or nature of the glass articles to be hardened. In particular the nature of the method used for hardening and/or strengthening is also immaterial. In particular, there is the possibility of use in the hardening and/or strengthening of utility glass, and equally in the hardening and/or strengthening of specialty glasses. Also possible in particular is an application in ion exchange in optical specialty glasses, for IR polarizers, for example.

In particular it is also immaterial how the regenerated salt melt comes into contact with the glass articles to be hardened and/or strengthened. In particular, immersion in a salt bath containing the salt melt is just as possible as sprinkling or spraying of the glass articles to be hardened and/or strengthened.

The regeneration material may in particular have been melted from a raw material mixture which as well as potassium oxide additionally comprises at least one further oxide, more particularly from the following group: aluminum oxide, boron oxide, sulfur oxide, calcium oxide. In particular it is possible advantageously for the regeneration material to have been melted from a raw material mixture which as well as potassium oxide additionally comprises two or more oxides, more particularly from the following group: aluminum oxide, boron oxide, sulfur oxide, calcium oxide, in equal or different fractions.

An especially advantageous and effective regeneration material is a material of the type stated above that has been melted from a raw material mixture which has a fraction of silicon oxide in the range from 40 percent by mass to 75 percent by mass, more particularly in the range from 50 percent by mass to 65 percent by mass, or of 57.5 percent by mass.

Alternatively or additionally, it is possible advantageously for the regeneration material to have been melted from a raw material mixture which has a fraction of potassium oxide in the range from 20 percent by mass to 40 percent by mass, more particularly in the range from 25 percent by mass to 35 percent by mass, or of 32.5 percent by mass. It has emerged that this range is especially advantageous for efficient functionality of the regeneration material. This is attributable in particular to the fact that the ion exchange in which the potassium important for regeneration of the salt melt is delivered operates especially well on the basis of the particular constitution of the glass network of the regeneration material that is present with this fraction of potassium oxide. Especially when using a raw material mixture having a fraction of potassium oxide of more than 40 percent by mass for the melting of the regeneration material, the functional capacity of the resultant regeneration material is lowered quite considerably, despite the presence of more potassium in the regeneration material. When using a raw material mixture having a fraction of potassium oxide of below 20 percent by mass, potassium is released from the regeneration material only very slowly to the salt melt.

Moreover, alternatively or additionally, it is possible advantageously for the regeneration material to have been melted from a raw material mixture which has a fraction of aluminum oxide in the range from 1 percent by mass to 10 percent by mass, more particularly in the range from 2 percent by mass to 6 percent by mass, or of 2.5 percent by mass or of 5 percent by mass.

Furthermore, alternatively or additionally, it is possible advantageously for the regeneration material to have been melted from a raw material mixture which has a fraction of calcium oxide in the range from 0 percent by mass to 15 percent by mass, more particularly in the range from 6 percent by mass to 10 percent by mass, or of 8 percent by mass.

Furthermore, alternatively or additionally, it is possible advantageously for the regeneration material to have been melted from a raw material mixture which has a fraction of boron oxide in the range from 0 percent by mass to 10 percent by mass.

Particularly advantageous, in particular, is a version in which the regeneration material comprises at least one alkaline earth metal.

For example, regeneration material may have been melted from a raw material mixture which comprises 2.5 percent by mass of aluminum oxide, 32 percent by mass of potassium oxide, 8 percent by mass of calcium oxide and 57.5 percent by mass of silicon oxide. It has emerged that with a regeneration material of this kind, introduced with a mass fraction of 5% into a contaminated salt melt bath, it is possible to achieve a lowering of the original sodium content by 60% or more within 24 hours.

For example, regeneration material may have been melted from a raw material mixture which comprises 5 percent by mass of aluminum oxide, 32.5 percent by mass of potassium oxide, 8 percent by mass of calcium oxide and 54.5 percent by mass of silicon oxide. It has emerged that a regeneration material of this kind may be employed to particularly good effect in the form of a nonwoven in a separate channel through which the salt melt for regeneration flows progressively or at time-spaced intervals.

Very generally it is possible advantageously for the regeneration material to be contacted with the salt melt progressively or at time-spaced intervals. This may be accomplished, for example, by introducing the regeneration material into a bath or into a container in which the salt melt for regeneration is located. The regeneration material is particularly effective if the regeneration material and the salt melt are agitated relative to one another. The plant of the disclosure may therefore advantageously comprise an agitating device which agitates the regeneration material progressively or at time-spaced intervals in the salt melt and/or agitates it into the salt melt.

Alternatively it is also possible for the regeneration material to be disposed in a separate channel, through which the salt melt for regeneration flows progressively or at time-spaced intervals. The plant of the disclosure may accordingly and advantageously comprise a pump for pumping the salt melt through the channel. The channel is preferably actively heated in order to prevent a temperature drop on the part of the salt melt within the channel and hence solidification of the salt melt in the channel.

The regeneration material may advantageously be contacted in the form of granules, for example, with the salt melt. In particular it is possible advantageously for the granules to have a particle size in the range from 0.1 mm to 0.8 mm, more particularly in the range from 0.3 mm to 0.8 mm. A particle size of this kind firstly offers the advantage that the granules can be held in a container having comparatively large openings, while at the same time it offers a high contact surface area for the salt melt.

Alternatively the regeneration material, at least partially, may be present advantageously in the form of glass frits or sintered material. A version of this kind as well firstly offers the advantage that regeneration material can be held in a container having comparatively large openings, while at the same time it offers a high contact surface area for the salt melt. The glass frits may have a thickness in the range from 0.1 mm to 0.8 mm, more particularly in the range from 0.3 mm to 0.8 mm.

Alternatively and with the same advantages it is also possible for the regeneration material, at least partially, to be rolled out to form plates and for the plates or fragments of the plates to be contacted with the salt melt. The plates or the fragments of the plates may advantageously have a thickness in the range from 0.1 mm to 0.8 mm, more particularly in the range from 0.3 mm to 0.8 mm.

The plates may advantageously be corrugated or irregularly corrugated. Very generally it is possible advantageously for the plates to have an irregular surface. This advantageously prevents the plates from clinging to one another.

Alternatively and with the same advantages it is also possible for the regeneration material, at least partially, to be contacted in the form of glass fibers or in the form of at least one nonwoven produced from glass fibers, or in the form of glass wool, with the salt melt.

The regeneration material may be introduced directly into the salt melt. Alternatively a container containing the regeneration material may be introduced into the salt melt, with the container having at least one opening through which the molten salt of the salt melt is able to flow, without the regeneration material being able to escape from the container. A version of this kind has the particular advantage that particles of the regeneration material, for example granular particles or glass frits, cannot disperse themselves uncontrolledly in the salt melt.

The container may be embodied for example as a cage, basket or sieve. The container is preferably manufactured from stainless steel. This prevents chemical reaction with the salt melt or with the regeneration material or with the glass articles to be hardened and/or strengthened.

As already mentioned, it is possible advantageously for the regeneration material to be agitated in the salt melt, more particularly progressively or at time-spaced intervals, in order to bring different parts of the salt melt continually into contact with the regeneration material. It is alternatively or additionally also possible, progressively or at time-spaced intervals, for one portion of the salt melt to be taken from a salt bath in which the glass hardening and/or glass strengthening process is taking place and to be brought into contact, more particularly into flowing contact, with the regeneration material, with the portion of the salt melt removed being subsequently introduced back into the salt bath.

In relation to the method of the disclosure for hardening and/or strengthening glass articles, more particularly glass articles made of utility glass, the use of the regeneration material does not have any deleterious effect on the glass articles for treatment. Accordingly, after the ion exchange process, the glass articles can be simply taken from the salt melt and cleaned to remove adhering potassium nitrate. The glass articles may more particularly be containers or flat glass.

### BRIEF DESCRIPTION OF THE DRAWING VIEWS

In the drawing, the subject matter of the disclosure is represented illustratively and schematically and is described below with reference to the figures, where elements that are the same or have the same effect, even in different exemplary embodiments, are usually provided with the same reference signs. In the figures:

FIG. 1 shows an exemplary embodiment of a plant of the disclosure for hardening and/or strengthening glass, and

FIG. 2 shows a further exemplary embodiment of a plant of the disclosure for hardening and/or strengthening glass.

### DETAILED DESCRIPTION

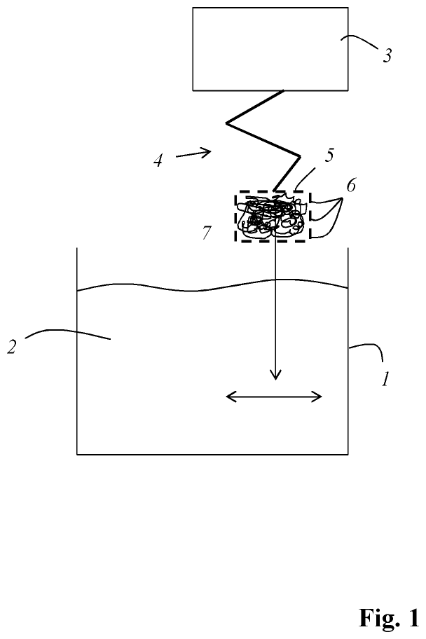

FIG. 1 shows an exemplary embodiment of a plant of the disclosure for hardening and/or strengthening glass, the plant comprising a salt bath 1 with a salt melt 2. The salt melt 2 comprises potassium nitrate or consists of potassium nitrate.

The plant also comprises an agitating device 3 having a robot arm 4 which carries a container 5. The container 5 has openings 6 through which the salt melt 2 is able to flow. Disposed within the container 5 is a regeneration material 7. The size of the openings 6 in the container 5 is such that the regeneration material 7 is unable to pass through. However, the salt melt 2 can flow through the openings 6.

The regeneration material 7 comprises a potassium-containing silicate glass or consists of a potassium-containing silicate glass.

By means of the agitating device 3, the container 5 with the regeneration material 7 is immersed in the salt melt 2. The agitating device 3 additionally agitates the container 5 with the regeneration material 7 within the salt melt, so increasing the effect of the regeneration material 7.

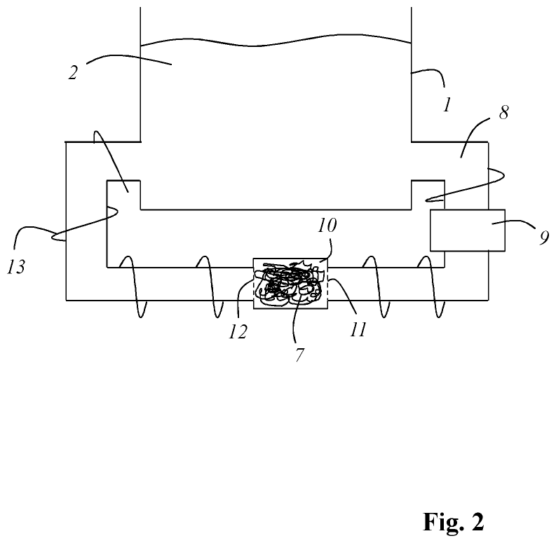

FIG. 2 shows a further exemplary embodiment of a plant of the disclosure for hardening and/or strengthening glass, the plant comprising a salt bath 1 with a salt melt 2. The salt melt 2 comprises potassium nitrate or consists of potassium nitrate.

The salt bath 1 is connected at two points to a channel 8 in which a pump 9 is located. The pump 9 removes a portion of the salt melt 2 from the salt bath 1 and returns it to the salt bath 1 after the melt has passed through the channel and through the regeneration material 7 located in the channel 8.

The channel 8 is actively heated by means of a heating wire 13 in order to prevent a drop in temperature of the salt melt 2 within the channel 8 and hence solidification of the salt melt 2 in the channel 8.

Located within the channel 8 is a chamber 10, which has an entry opening closed with a first lattice 11, and an exit opening closed with a second lattice 12. The size of the lattices 11, 12 is such that the salt melt 2 is able to flow through, but the regeneration material 7 cannot pass through.

### LIST OF REFERENCE SIGNS

1 salt bath
2 salt melt
3 agitating device
4 robot arm
5 container
6 openings
7 regeneration material
8 channel
9 pump
10 chamber
11 first lattice
12 second lattice
13 heating wire

1. The use of potassium-containing silicate glass as regeneration material (7) for regenerating a salt melt (2) which is used for a glass hardening and/or glass strengthening process and which comprises potassium nitrate or consists of potassium nitrate.

2. The use as claimed in claim 1, characterized in that the regeneration material (7) has been melted from a raw material mixture which as well as potassium oxide additionally comprises at least one further oxide, more particularly from the following group: aluminum oxide, boron oxide, sulfur oxide, calcium oxide.

3. The use as claimed in claim 1, characterized in that
a. the regeneration material (7) has been melted from a raw material mixture which as well as potassium oxide additionally comprises two or more oxides, more particularly from the following group: aluminum oxide, boron oxide, sulfur oxide, calcium oxide, or in that
b. the regeneration material (7) has been melted from a raw material mixture which as well as potassium oxide additionally comprises two or more oxides, more particularly from the following group: aluminum oxide, boron oxide, sulfur oxide, calcium oxide, in different fractions.

4. The use as claimed in claim 1, characterized in that the regeneration material (7) has been melted from a raw material mixture which has a fraction of silicon oxide in the range from 40 percent by mass to 75 percent by mass, more particularly in the range from 50 percent by mass to 65 percent by mass, or of 57.5 percent by mass.

5. The use as claimed in claim 1, characterized in that the regeneration material (7) has been melted from a raw material mixture which has a fraction of potassium oxide in the range from 20 percent by mass to 40 percent by mass, more particularly in the range from 25 percent by mass to 35 percent by mass, or of 32.5 percent by mass.

6. The use as claimed in claim 1, characterized in that the regeneration material (7) has been melted from a raw material mixture which has a fraction of aluminum oxide in the range from 1 percent by mass to 10 percent by mass, more particularly in the range from 2 percent by mass to 6 percent by mass, or of 2.5 percent by mass or of 5 percent by mass.

7. The use as claimed in claim 1, characterized in that the regeneration material (7) has been melted from a raw material mixture which has a fraction of calcium oxide in the range from 0 percent by mass to 15 percent by mass, more particularly in the range from 6 percent by mass to 10 percent by mass, or of 8 percent by mass.

8. The use as claimed in claim 1, characterized in that the regeneration material (7) has been melted from a raw material mixture which has a fraction of boron oxide in the range from 0 percent by mass to 10 percent by mass.

9. The use as claimed in claim 1, characterized in that the regeneration material (7) contains at least one alkaline earth metal.

10. The use as claimed in claim 1, characterized in that the regeneration material (7) is contacted progressively or at time-spaced intervals with the salt melt (2).

11. The use as claimed in claim 1, characterized in that the regeneration material (7) in the form of granules is contacted with the salt melt (2).

12. The use as claimed in claim 11, characterized in that the granules have a particle size in the range from 0.3 mm to 0.8 mm.

13. The use as claimed in claim 1, characterized in that the regeneration material (7) in the form of glass frits or sintered material is contacted with the salt melt (2).

14. The use as claimed in claim 13, characterized in that the glass frits have a thickness in the range from 0.1 mm to 0.8 mm.

15. The use as claimed in claim 1, characterized in that the regeneration material (7) is rolled out to form plates and in that the plates or fragments of the plates are contacted with the salt melt (2).

16. The use as claimed in claim 15, characterized in that plates or the fragments of the plates have a thickness in the range from 0.1 mm to 0.8 mm.

17. The use as claimed in claim 1, characterized in that the regeneration material (7) in the form of glass fibers or in the form of at least one nonwoven produced from glass fibers or in the form of glass wool is contacted with the salt melt (2).

18. The use as claimed in claim 1, characterized in that the regeneration material (7) is introduced directly into the salt melt (2).

19. The use as claimed in claim 1, characterized in that a container (5) which contains the regeneration material (7) is introduced into the salt melt (2), the container (5) having at least one opening (6) through which the molten salt of the salt melt (2) can flow without the regeneration material (7) being able to escape from the container (5).

20. The use as claimed in claim 19, characterized in that the container (5) is embodied as a cage, a basket or a sieve.

21. The use as claimed in claim 19, characterized in that the container (5) is manufactured from stainless steel.

22. The use as claimed in claim 1, characterized in that the regeneration material (7) is agitated in the salt melt (2), more particularly progressively or at time-spaced intervals.

23. The use as claimed in claim 1, characterized in that progressively or at time-spaced intervals, a portion of the salt melt (2) is taken from a salt bath (1) in which the glass hardening and/or glass strengthening process takes place, and it is brought into contact, more particularly into flowing contact, with the regeneration material (7), and in that the portion of the salt melt (2) is subsequently reintroduced into the salt bath (1).

24. The use as claimed in claim 1, characterized in that the portion of the salt melt (2) is passed progressively or at time-spaced intervals through a channel in which the regeneration material (7) is located.

25. A method for producing glass, more particularly utility glass, characterized in that regeneration material (7) consumed in the context of the use as claimed in claim 1 is used as raw material for the glass.

26. The method as claimed in claim 25, characterized in that the regeneration material (7) is taken from the salt melt (2) and cleaned to remove adhering potassium nitrate.

27. A regeneration material (7) for regenerating a salt melt (2) which is used for a glass hardening and/or glass strengthening process and which comprises potassium nitrate or consists of potassium nitrate, characterized in that the regeneration material (7) comprises a potassium-containing silicate glass or consists of a potassium-containing silicate glass.

28. The regeneration material (7) as claimed in claim 27, characterized in that the regeneration material (7) has been melted from a raw material mixture which as well as potassium oxide additionally comprises at least one further oxide, more particularly from the following group: aluminum oxide, boron oxide, sulfur oxide and calcium oxide.

29. The regeneration material (7) as claimed in claim 27, characterized in that the regeneration material (7) has been melted from a raw material mixture which as well as potassium oxide additionally comprises two or more oxides, more particularly from the following group: aluminum oxide, boron oxide, sulfur oxide and calcium oxide, or in that the regeneration material (7) additionally comprises two or more oxides, more particularly from the following group: aluminum oxide, boron oxide, sulfur oxide and calcium oxide, in different fractions.

30. The regeneration material (7) as claimed in claim 27, characterized in that the regeneration material (7) has been melted from a raw material mixture which has a fraction of silicon oxide in the range from 40 percent by mass to 75 percent by mass, more particularly in the range from 50 percent by mass to 65 percent by mass, or of 57.5 percent by mass.

31. The regeneration material (7) as claimed in claim 27, characterized in that the regeneration material (7) has been melted from a raw material mixture which has a fraction of potassium oxide in the range from 20 percent by mass to 40 percent by mass, more particularly in the range from 25 percent by mass to 35 percent by mass, or of 32.5 percent by mass.

32. The regeneration material (7) as claimed in claim 27, characterized in that the regeneration material (7) has been melted from a raw material mixture which has a fraction of aluminum oxide in the range from 1 percent by mass to 10 percent by mass, more particularly in the range from 2 percent by mass to 6 percent by mass, or of 2.5 percent by mass or of 5 percent by mass.

33. The regeneration material (7) as claimed in claim 27, characterized in that the regeneration material (7) has been melted from a raw material mixture which has a fraction of calcium oxide in the range from 0 percent by mass to 15 percent by mass, more particularly in the range from 6 percent by mass to 10 percent by mass, or of 8 percent by mass.

34. The regeneration material (7) as claimed in claim 27, characterized in that the regeneration material (7) has been melted from a raw material mixture which has a fraction of boron oxide in the range from 0 percent by mass to 10 percent by mass.

35. The regeneration material (7) as claimed in claim 27, characterized in that the regeneration material (7) contains at least one alkaline earth metal.

36. The regeneration material (7) as claimed in claim 27, characterized in that the regeneration material (7) comprises granules.

37. The regeneration material (7) as claimed in claim 36, characterized in that the granules have a particle size in the range from 0.3 mm to 0.8 mm.

38. The regeneration material (7) as claimed in claim 27, characterized in that the regeneration material (7) is embodied as sintered material and/or as glass frits.

39. The regeneration material (7) as claimed in claim 38, characterized in that glass frits have a thickness in the range from 0.1 mm to 0.8 mm.

40. The regeneration material (7) as claimed in claim 27, characterized in that the regeneration material (7) has been rolled out to form plates or in that the regeneration material (7) is embodied in the form of plate fragments.

41. The regeneration material (7) as claimed in claim 40, characterized in that plates have a thickness in the range from 0.1 mm to 0.8 mm.

42. The regeneration material (7) as claimed in claim 27, characterized in that the regeneration material (7) is embodied in the form of glass fibers or in the form of at least one nonwoven produced from glass fibers, or in the form of glass wool.

43. A plant for hardening and/or strengthening glass, comprising a salt bath (1) with a salt melt (2) which comprises potassium nitrate or consists of potassium nitrate, characterized in that the plant has a regeneration material (7) as claimed in claim 27 which is contacted progressively with the salt melt (2) or is contactable at time-spaced intervals with the salt melt (2).

44. The plant as claimed in claim 43, characterized in that the regeneration material (7) is introduced or introducible directly into the salt melt (2).

45. The plant as claimed in claim 43, characterized in that the plant has a container (5) which is introduced or can be introduced into the salt melt (2) and which comprises the regeneration material (7), the container (5) having at least one opening (6) through which the molten salt of the salt melt (2) can flow.

46. The plant as claimed in claim 45, characterized in that the container (5) is embodied as a cage, basket or sieve.

47. The plant as claimed in claim 45, characterized in that the container (5) is manufactured from stainless steel.

48. The plant as claimed in claim 43, characterized in that the plant has an agitating device (3) which agitates the regeneration material (7) progressively or at time-spaced intervals in the salt melt (2) and/or agitates said material into the salt melt (2).

49. The plant as claimed in claim 43, characterized in that the plant has a channel (8) in which the regeneration material (7) is located and through which a portion of the salt melt (2) can be passed progressively or at time-spaced intervals.

50. The plant as claimed in claim 49, characterized in that the plant has a pump (9) for pumping the salt melt (2) through the channel (8).

51. A method for hardening and/or strengthening glass articles, characterized in that the glass to be hardened and/or strengthened is immersed in a salt melt (2) which comprises potassium nitrate or consists of potassium nitrate, and in that the salt melt (2) is contacted progressively or at time-spaced intervals with a regeneration material (7) as claimed in claim 27.
